(19) United States
(12) Patent Application Publication
(10) Pub. No.: US 2010/0070653 A1
(43) Pub. Date: Mar. 18, 2010

(54) IO Card Receiving Unit

(76) Inventor: Vedran Degoricija, Los Gatos, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/233,148

(22) Filed: Sep. 18, 2008

(51) Int. Cl. G06F 3/00; G06F 13/36

(52) U.S. Cl. 710/1; 710/306

(57) ABSTRACT

A system comprises a chassis, an IO interconnect assembly provided in the chassis, and a plurality of IO card receiving units that are installable in the chassis. When the IO card receiving units are installed, the receiving units couple to the IO interconnect assembly. Each IO card receiving unit connects to a corresponding connector on the IO interconnect assembly and provides one or more slots for receiving IO cards. At least one IO card receiving unit has a different number of slots for receiving IO cards than at least one other IO card receiving unit.

### BACKGROUND

Many computer systems have a backplane which is a circuit board to which other circuit boards connect to provide electrical connectivity between such boards. Each connector on a backplane to which a circuit board can be connected is predefined to comply with a particular electrical protocol. Although different types of circuit boards can be connected to some backplanes, the system architect designs the backplane to accommodate a predefined number and type of circuit boards of a particular type. Mixing and matching of different circuit boards in such a system is generally not permitted. The inability of a user to install a different set of circuit boards in a system than that system's backplane can accommodate is undesirable for the user.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a perspective view of the system of FIG. 1 with one combination of IO receiving units; and

FIG. 3 shows a perspective view of the system of FIG. 1 with another combination of IO receiving units.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

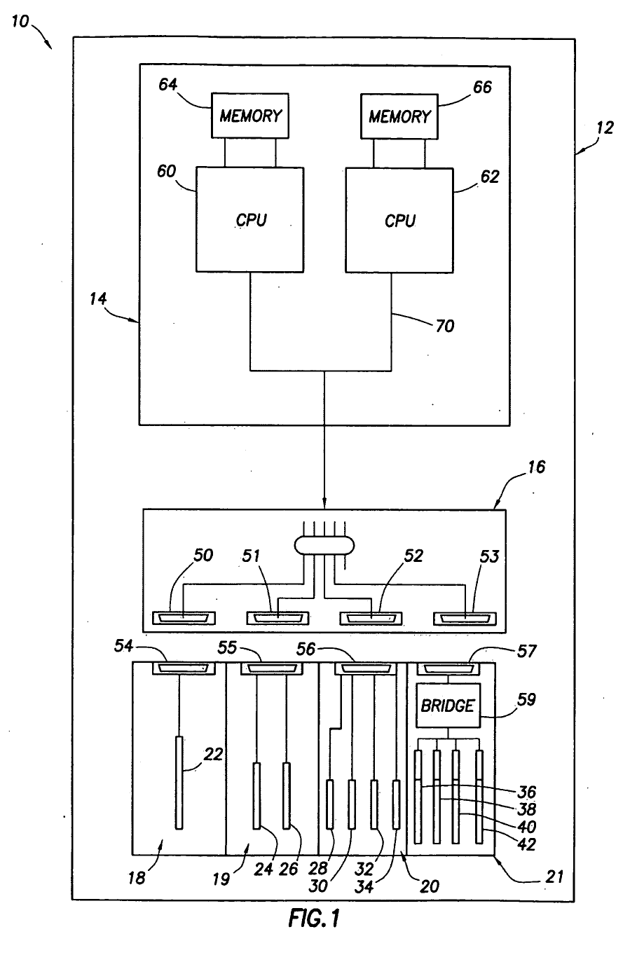

FIG. 1 shows a diagram of a system 10 in accordance with various embodiments. The system 10 may comprise a computer (e.g., server) or other type of electronic system. As shown, system 10 comprises a chassis 12 that contains a system board 14, an input/output (IO) interconnect assembly 16, and one or more IO card receiving units 18-21. The system board 14 contains various electronic components such as one or more central processing units (CPUs) 60 and 62 and memory devices 64 and 66 electrically coupled to corresponding CPUs. The electronic components (e.g., CPUs 60, 62 and memory devices 64, 66) are mounted on the system board 14, which comprises a printed circuit board (PCB). The system board 14 also contains an IO link 70 to the IO interconnect assembly 16. The IO link 70 comprises a plurality of signals.

The IO interconnect assembly 16 receives the IO link 70 and divides the communication link's signals to a plurality of electrical connectors. Four electrical connectors 50-53 are shown in the embodiment of FIG. 1, but any number of connectors can be provided on the IO interconnect assembly 16. Each connector 50-53 connects to a corresponding connector on an IO card receiving unit 18-21. The connectors 50-53 may all be identical.

Each IO card receiving unit 18-21 contains one or more slots. Each slot is capable of receiving an IO card (e.g., graphics card, network interface card, etc.). IO card receiving unit 18 comprises a single slot 22. IO card receiving unit 19 comprises a two slots 24 and 26. IO card receiving units 20 and 21 each have four slots 28-34 and 36-42, respectively. As can be seen, at least one IO card receiving unit may have a different number of slots for receiving IO cards than at least one other IO card receiving unit. The number of slots in each IO card receiving unit can be varied from that shown in FIG. 1.

Each IO card receiving unit 18-21 accepts one or more cards (the number depends on the number of slots in the receiving unit) of a particular type. The card type can vary among the IO card receiving units. Thus, one IO card receiving unit can receive cards of a different type than another IO card receiving unit. For example, one IO card receiving unit may receive one or more PCI-X IO cards while another IO card receiving unit may receive PCI-e IO cards. In accordance with various embodiments, each IO card receiving unit receives IO cards of a predefined “personality” (e.g., PCI-e, PCI-X, etc.). Such personality is defined by the respective IO card receiving unit 18-21, not the IO interconnect assembly 16. Instead, the IO interconnect assembly 16 is generic to all of the IO card receiving units 18-21 providing an identical, in at least some embodiments, electrical interface to each IO card receiving unit.

The IO card receiving units 18-21 comprise housings that are easily removable and replaceable, and each housing as connector 54-57 mounted thereon. Each IO card receiving unit 18-21 may slide along fails (not shown) in the system chassis 12 when being installed in the chassis. The connectors 54-57 on the IO card receiving units 18-21 may blind-mate to their corresponding connectors 50-53 on the IO interconnect assembly 16, or connect via cables to the IO interconnect assembly as desired. The system board 14 and IO interconnect assembly are not intended to be removed by a user and certainly not needed to be removed in order to reconfigure the system 10 for a different set of IO cards. Instead, the user chooses, from among a plurality of choices, whichever IO card receiving units the user desires. The choice of IO card receiving units is generally based on the number and types of IO cards the user desires to install in the system. For example, if the user desires to install IO cards of a single type, then the user selects and installs the IO card receiving units corresponding to that particular type. If, however, the user desires to install a mix of types of IO cards, for example PCI-E and PCI-X cards, then the user selects and installs IO card receiving units corresponding to the desired types. The user can thus configure the system 10 for a user-desired mix of IO card types by selecting the desired IO card receiving units.

Some IO card receiving units (e.g., IO card receiving units 18-20) do not have any active logic to perform signal conversion. Other IO card receiving units (e.g., receiving unit 21) comprises active logic (e.g., bridge 59) to convert the system board communication interface (from link 70) to a different format for the corresponding slots in that receiving unit (slots 36-42 in the example of receiving unit 21). Such conversion logic may comprise a bridge or other form of conversion logic.

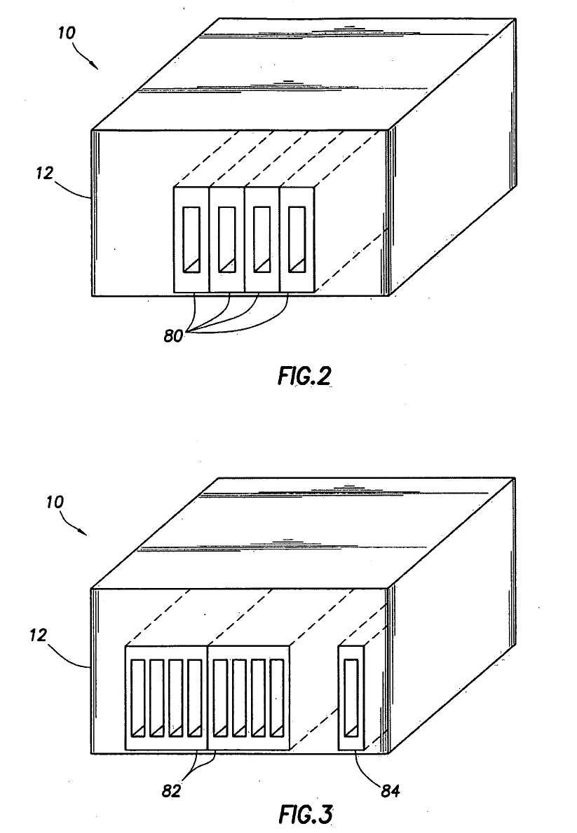

FIGS. 2 and 3 show illustrative perspective views of system 10. In the example of FIG. 2, the system comprises four IO receiving units 80 that are identical and each has a single slot for a single IO card. In the example of FIG. 3, the system comprises two IO receiving units 82 with each receiving up to four identical IO cards. The system also comprises an IO card receiving unit 84 that has only a single slot for receiving a single IO card whose type may be different from the IO cards that can be received into IO receiving units 82.

In some embodiments as described above, a method comprising a person connecting a plurality of IO card receiving units into the computer chassis. Each IO card receiving unit connects to the IO interconnect assembly. Each IO card receiving unit has at least one slot for receiving an IO card. Further, at least one IO card receiving unit has a different number of slots for receiving IO cards than at least one other IO card receiving unit installed in the system by the person. The method may further comprise replacing one of the IO card receiving units with a different IO card receiving unit that has a different number of slots than the IO card receiving unit it replaces.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a chassis;
an IO interconnect assembly provided in said computer chassis;
a plurality of IO card receiving units that are installable in said computer chassis and, when installed, couple to said IO interconnect assembly;
wherein each IO card receiving unit connects to a corresponding connector on the IO interconnect assembly and provides one or more slots for receiving IO cards, at least one IO card receiving unit has a different number of slots for receiving IO cards than at least one other IO card receiving unit.

2. The system of claim 1 further comprising a system board, and wherein the IO interconnect assembly connects to the system board, and wherein at least one IO card receiving unit comprises logic that converts a system board communication interface to a different format for said at least one IO card.

3. The system of claim 1 further wherein at least one IO card receiving unit has four slots for receiving four IO cards and at least other IO card receiving unit has only one slot for receiving a single IO card.

4. The system of claim 1 wherein the IO interconnect assembly comprises a circuit board having a plurality of electrical connectors, and wherein each IO card receiving unit connects to a corresponding electrical connector on the IO interconnect assembly's circuit board, and wherein the electrical connectors on the interconnect assembly's circuit board are identical.

5. The system of claim 1 wherein at least one IO card receiving unit receives an IO card having a different electrical interface than an IO card received in at least one other IO card receiving unit.

6. The system of claim 1 wherein at least one IO card receiving unit receives a PCI-X IO card and at least one other IO card receiving unit receives a PCI-E IO card.

7. The system of claim 1 wherein each IO card receiving unit comprises a housing that has a connector for connecting to a corresponding connector on the IO interconnect assembly, said housing defining said one or more slots.

8. A system, comprising:
a chassis;
an IO interconnect assembly provided in said computer chassis;
a plurality of IO card receiving units that are installable in said computer chassis and, when installed, couple to said IO interconnect assembly;
wherein each IO card receiving unit connects to a corresponding connector on the IO interconnect assembly and provides one or more slots for receiving IO cards, wherein for at least one IO card receiving unit, the one or more slots have a different electrical interface than the one or more slots of at least one other IO card receiving unit.

9. The system of claim 8 further comprising a system board, and wherein the IO interconnect assembly connects to the system board, and wherein at least one IO card receiving unit comprises logic that converts a system board communication interface to a different format for said at least one IO card.

10. The system of claim 8 wherein at least one IO card receiving unit has a different number of slots for receiving IO cards than at least one other IO card receiving unit.

11. The system of claim 8 wherein the IO interconnect assembly comprises a circuit board having a plurality of electrical connectors, and wherein each IO card receiving unit connects to a corresponding electrical connector on the IO interconnect assembly's circuit board, and wherein the electrical connectors on the interconnect assembly's circuit board are identical.

12. The system of claim 8 wherein at least one IO card receiving unit receives a PCI-X IO card and at least one other IO card receiving unit receives a PCI-e IO card.

13. A method, comprising:
connecting a plurality of IO card receiving units into a computer chassis, each IO card receiving unit connects to an IO interconnect assembly, and each IO card receiving unit has at least one slot for receiving an IO card and at least one IO card receiving unit has a different number of slots for receiving IO cards than at least one other IO card receiving unit.

14. The method of claim 13 further comprising replacing a first IO card receiving unit in said chassis with a second IO card receiving unit that has a different number of slots than the first IO card receiving unit.
